(19) United States
(12) Patent Application Publication
(10) Pub. No.: US 2017/0334104 A1
(43) Pub. Date: Nov. 23, 2017

(54) Process for Producing a Foam Film Laminate and Use Thereof

(71) Applicant: Benecke-Kaliko AG, Hannover (DE)

(72) Inventors: Joseph Mani, Eislingen (DE); Thomas Malner, Göppingen (DE); Jürgen Bühring, Wedemark (DE); Volker Hülsewede, Schlat (DE)

(73) Assignee: Benecke-Kaliko AG, Hannover (DE)

(21) Appl. No.: 15/525,596

(22) PCT Filed: Aug. 3, 2015
(86) PCT No.: PCT/EP2015/067761

§ 371 Date: May 10, 2017

(30) Foreign Application Priority Data
Nov. 11, 2014 (DE) 10 2014 222 958.8

(51) Int. Cl. B29C 41/32; B29C 44/34; B32B 5/20; B29C 44/50; B60R 13/02; C08J 9/08; B32B 27/32; B32B 27/06; B29K 23/00; B29K 105/04

(52) U.S. Cl. CPC B29C 41/32; B32B 27/32; B29C 44/3457; B29C 44/3484; B32B 5/20; B32B 27/065; B29C 44/505; B60R 13/02; C08J 9/08; B29K 2105/04; B29K 2023/06; B29K 2023/12; C08J 2201/026; C08J 2201/03; C08J 2203/02; C08J 2323/06; C08J 2323/12

(57) ABSTRACT

The invention relates to a process for producing a foam film laminate having at least one compact outer layer and at least one layer composed of extruded foamed polymer bound to the outer layer, wherein the production of the layer of foamed polymer is effected in such a way that a polymer material is admixed with a chemical blowing agent which is solid at room temperature and, during or after the extrusion, is heated up to or above the activation temperature of the blowing agent, in order to obtain the layer of foamed polymer, wherein the processes is characterized in that the polymer material contains 5% to 60% by weight of at least one HMS polyolefin having a in accordance with ISO 20965 (as at 15 Feb. 2005, measurement apparatus type A) of 10⁴ to 10⁷ Pa s measured at 190° C. within a range of Hencky strain rate of 0.01 s⁻¹ to 1 s⁻¹ at a Hencky strain of 3.0. The invention further relates to a polymer composition for the foam layer for performance of the process and to a multilayer polymer film produced by the process and to the use thereof.

The invention relates to a process for producing a foam film laminate comprising at least one compact covering layer and at least one layer of extruded foamed plastic (foam layer) joined to the covering layer, wherein the production of the layer of foamed plastic is effected in a manner where a plastics material is admixed with a chemical blowing agent which is solid at room temperature and during or after extrusion is heated to or above the activation temperature of the blowing agent to obtain the layer of foamed plastic. The invention further relates to a plastic composition for the foam layer for performing the process and to a multilayered plastic film produced by the process and also to the use thereof.

DE 10018196 A1 discloses decorative sheet materials based on polyolefins. For applications and components in which the sheet material is subjected to severe stretching (e.g. >200%) in downstream thermal forming processes it is preferable to use compact film constructions which may be constructed from a plurality of layers. These materials generally have a density of >800 kg/m³ at a thickness of 0.5-3.0 mm and the components thus have a correspondingly high weight and, consequently, high raw material requirements.

For applications and components in which the sheet material is subjected to only low stretching of <200% in downstream thermal forming processes sheet materials having at least one foamed layer, so-called foam layers, may be employed. The thickness of the compact covering layer may be reduced to 0.2-0.8 mm and may have a density of >800 kg/m³. The foamed layer is generally formed with a density of from 20 to 200 kg/m³ and a thickness of from 0.5 to 4.0 mm. The foamed layer exhibits an elastic reaction to compressive stress thus imbuing the components with pleasant pressure haptics. The low density of the foamed layer reduces the weight of the components and the raw material requirements necessary for production.

DE 10 2005 050524 A1 discloses a congeneric process for producing a plastic foam material. For the production thereof 5-100 wt % of one or more polyethylene-based plastics having a weight fraction of ethylene of >50 wt % and optionally up to 95 wt % of one or more polypropylene-based plastics having a weight fraction of polypropylene of >50 wt % are mixed with a crosslinking agent and a chemical blowing agent and also further process additives such as glidants, stabilizers and pigments for example. A film is produced therefrom by extrusion. This film is crosslinked using an ionizing radiation source in a subsequent process step to increase melt elasticity. In a downstream heating process a sheetlike plastics foam material having a density of 20-200 kg/m³ and a thickness of 0.5-4.0 mm is obtained with the aid of the blowing agent. The foaming process may be performed vertically in a foaming oven or horizontally in a salt bath for example.

The thus obtained plastic foam material may subsequently be joined by thermal means or by adhesive bonding to surface materials based on polyolefins, PVC or polyurethanes to afford a multilayered sheet article and provided with a three-dimensional texture by an embossing process. This may be followed by forming by means of thermoforming, in-mold graining or low-pressure molding. These shapes or articles find application in airplanes, railway vehicles, ships and in motor vehicles, in particular as motor vehicle interior trim or trim parts. While this process can produce fine-celled foam layers with uniform foam cell distribution it may be seen as a disadvantage that extrusion and foaming are two separate process steps, thus rendering the process rather time-consuming overall.

U.S. Pat. No. 4,473,665 A1 discloses a process where a plastic foam material based on a polyolefin composition is produced when the polymer mixture at a temperature above the glass transition temperature is laden with an inert gas under positive pressure, the gas-laden melt is subsequently decompressed and said melt is then cooled to below the glass transition temperature. This process principle allows a plastic foam material based on a polyolefin composition having a density of 20 kg/m³-800 kg/m³ to be produced via extrusion or an injection molding process. While this process does allow sheet materials having a foam layer to be produced in one process step the foam layers in the density range <100 kg/m³ generally show a coarse-celled foam structure having a broad cell size distribution which is not satisfactory for all fields of application.

The thus produced foamed polyolefin-based sheet materials find application inter alia in the construction sector (e.g. as sound insulation in laminate floors, heat insulation for pipes, edging strips in floor laying) and in the packaging sector. On account of the predominately thermoplastic character of the sheet materials provided according to this process principle, said sheet materials are thus far not suitable for above-described thermal forming processes for producing three-dimensional formed bodies for use as motor vehicle interior trim or trim parts for example.

Further processes for producing multilayered plastic films are disclosed for example in WO 2008148918 A1, EP 291764 B1, EP 297293 A2, EP 413912 B1, EP 2027995 A1, JP 2001-096602 A, JP 2005-119274 A and WO 9961520 A1.

The present invention has for its object the provision of a process which requires fewer process steps while allowing the production of multilayered foam film laminates comprising a fine-celled foam layer having a uniform foam cell distribution. The foam film laminate shall additionally have sufficient stability to allow deep drawing at stretch ratios of >300% while being thermally formable and exhibiting sufficient stability to pressure and heat to allow use in dashboard trim in motor vehicles for example.

This object is achieved by a process for producing a foam film laminate comprising at least one compact covering layer and at least one layer of extruded foamed plastic (foam layer) joined to the covering layer, wherein the production of the layer of foamed plastic is effected in a manner where a plastics material is admixed with a chemical blowing agent which is solid at room temperature and during or after extrusion is heated to or above the activation temperature of the blowing agent to obtain the layer of foamed plastic, wherein the process is characterized in that the plastic material contains 5 to 60 wt % (based on the plastics material) of at least one HMS polyolefin (High Melt Strength polyolefin) having a stretching viscosity according to ISO 20965 (as at Feb. 15, 2005, type A measuring apparatus) of 10⁴ to 10⁷ Pa s measured at 190° C. in a Hencky strain rate range of 0.01 s⁻¹ to 1 s⁻¹ at a Hencky strain of 3.0.

The invention is based on the realization that the use of HMS polyolefins coupled with the use of a chemical blowing agent allows a foamed plastic layer to be produced directly with the extrusion. However, this is not possible in the process disclosed in DE 10 2005 050 524 A1 because the extruded plastic layer must initially be postcrosslinked before activation of the chemical blowing agent since otherwise a uniform foam structure is not obtained. However, on account of the use of at least one HMS polyolefin provided for in accordance with the invention in the process according to the invention the polymer melt already has a sufficient viscosity in the extruder to ensure that the gas formed from the chemical blowing agent is substantially retained in the polymer melt, i.e. does not escape. This not only produces a foam layer with uniform pore size distribution and fine cells but also simplifies the process since the foaming can be effected simultaneously with the extrusion.

In the context of the present invention a compact covering layer is to be understood as meaning a layer of unfoamed material which may be formed by a plastic film or else a metal film for example.

The foam film laminates produced by the process according to the invention feature very high stability which allows deep drawing at stretch ratios of >300%, preferably >400%, particularly preferably >500%.

In the context of the present invention stretching viscosity is to be understood as meaning the transient (stress altering) stretching viscosity which is determined according as per the ISO 20965 standard (as at Feb. 15, 2005) on a type A measuring apparatus according to chapter 5.1 of this standard at 190° C. in a Hencky strain rate range of 0.01 s⁻¹ to 1 s⁻¹ at a Hencky strain of 3.0. In accordance with the process according to the invention the HMS polyolefin has a stretching viscosity according to ISO 20965 (as at Feb. 15, 2005, type A measuring apparatus) of 10⁴ to 10⁷ Pa s measured at 190° C. in a Hencky strain rate range of 0.01 s⁻¹ to 1 s⁻¹ at a Hencky strain of 3.0. Such HMS polyolefins are commercially available from various producers. Said polyolefins are highly branched and have the property of being more viscous at low shear rates than polymers having the same molecular weight but a lower degree of branching while showing a more pronounced decline in viscosity at high shear rates.

According to a preferred embodiment of the process according to the invention the plastics material contains 10 to 55 wt % of the HMS polyolefin, in particular 15 to 50 wt %. This is particularly advantageous because a plastic material having these contents of HMS polyolefins are readily extrudable under customary temperature conditions while simultaneously having a sufficient retaining capacity in the polymer melt for the gases produced from the chemical blowing agent, so that the layer of foamed plastic obtained after extrusion features a very fine and uniform pore distribution.

HMS polyolefins that may be used for the process according to the invention are for example HMS polyethylene, HMS polypropylene, copolymers thereof or mixtures thereof. Preferably employed copolymers are polyethylene- and/or polypropylene-based copolymers. These are to be understood as meaning co- or else terpolymers where the monomer proportion is at least 50 wt % of ethylene (for polyethylene-based polymers) or propylene (for polypropylene-based polymers) monomers.

The process according to the invention may in principle employ any chemical blowing agents known to those skilled in the art for use in plastics. These are selected for example from endothermic and exothermic solid chemical blowing agents, such as citric acid and salts thereof, in particular the alkali metal, alkaline earth metal and ammonium salts thereof, sodium hydrogencarbonate, azodicarbonamide or mixtures of the abovementioned substances. These chemical blowing agents are preferred because they have decomposition temperatures in a temperature range typically used in the extrusion of plastics materials for producing foamed layers. In addition, thermal decomposition of the abovementioned chemical blowing agents generally releases toxicologically safe gases and does not release substances deleterious to the stability of the polymers used. A further advantage of solid chemical blowing agents compared to direct injection of a gas is that the solid chemical blowing agents simultaneously function as nucleation centers for gas bubble formation on account of their particulate structure, thus affording a very uniform and fine-pored foam structure.

It is also possible to add nucleating agents to the plastics material, for example talc, silicon oxide or titanium dioxide. The nucleating agents may be useful for further optimization of the cell structure.

The solid chemical blowing agents used in the context of the process according to the invention typically have activation temperatures of 180° C. or more, in particular 200° C. or more. Through appropriate choice of the chemical blowing agent the activation temperature thereof may also be chosen such that this activation temperature is not yet achieved or is exceeded during extrusion of the plastics material, as desired. This also allows the step of foaming to be effected at a later juncture provided that this is desired. This may be effected in a manner known per se via a foaming oven or a salt bath, as described in DE 10 2005 050 524 A1. However in the context of the present invention it is preferable when the activation temperature of the solid chemical blowing agent is already achieved/exceeded in the extrusion process, thus rendering obsolete the additional step of subsequent foaming.

The usage amount of solid chemical blowing agent depends on the desired foam properties and also on the relative gas quantity released by the chemical blowing agent. Typical usage amounts of solid chemical blowing agent based on the plastics material for the layer of foamed plastic are for example 0.1 to 5 wt %, preferably 0.25 to 3 and particularly preferably 0.5 to 2 wt %. These usage amounts are advantageous because they release gas quantities which bring about the typically desired extent of foaming in the foam material layer.

It may moreover be of advantage when the solid chemical blowing agent is in a particular particle size range. This makes it possible, after homogeneous incorporation of the solid chemical blowing agent into the polymer material, to control the pore size for the foam material layer. It is typically advantageous when the pores do not overwrite a certain size. To this end the solid chemical blowing agent may be employed with an average particle size of 1 to 25 μm, preferably of 5 to 15 μm. Average particle size here describes average particle diameter and may be determined by methods known per se such as scanning electron microscopy.

The admixing of the plastics material with the solid chemical blowing agent may in principle be effected in any manner known to one skilled in the art for this purpose. During mixing the plastic material may be present as a melt, as a pellet material or in powder form for example. When the plastics material is employed in the form of a melt, said melt should be temperature controlled such that it is below the activation temperature of the blowing agent, preferably at least 10° C. below the activation temperature of the blowing agent. Undesired premature foaming of the plastics material could otherwise occur.

The process according to the invention may employ various extrusion apparatuses. Examples include tandem extruders or twin-screw extruders. The die may be configured in various ways, for example in the form of a slit die, an annular die, a multi-orifice die or a slabstock slot die. It is also possible to employ coextrusion apparatuses for simultaneous extrusion of the covering layer and the foamed layer.

The pressure prevailing inside the extruder, ahead of the extrusion die, is typically at least 70 bar, preferably at least 100 bar, particularly preferably at least 120 bar. The reduction in pressure of from more than 70 bar ahead of the die to atmospheric pressure behind the die causes the polymer mixture laden with the gases from the solid chemical blowing agent to expand such that a product uniformly foamed throughout is formed. This production process for the foam allows foam densities of 20 to 800 kg/m³ to be produced at a film thickness of 0.5 to 3.0 mm.

The process according to the invention is directed to the production of a foam film laminate, i.e. the layer of foamed plastic is provided with a compact covering layer. The compact covering layer may for example be a sheet material based on polyolefins, PVC, polyurethanes, polyamides, polyesters, polylactides, cellulose or lignin. For good producibility of the multilayered plastics material film coupled with good product properties it has proven advantageous when in the process the covering layer and/or the layer of foamed plastics material are based on polyolefins, preferably on polyethylene or polypropylene.

The application of a varnish applied to the decorative side is likewise advantageous for achieving surface properties such as scratch resistance.

The bonding of these two layers may for example be effected after extrusion and cooling of the layer of foamed plastic below the melting temperature of the plastics material by joining the compact covering layer with the foam layer by thermal means or by adhesive bonding. Alternatively the covering layer and the layer of foamed plastic may also be joined directly in the course of the extrusion by coextrusion. This procedure is particularly advantageous because it not only produces a strong material bond between the compact covering layer and the foam layer without additional adhesive being required therefor but also eschews the additional step otherwise needed for joining these two material layers, thus making the process simpler.

The extrusion step for the foam layer is customarily followed by a subsequent crosslinking of the polymer material of at least the foam layer in order to provide said layer with sufficient mechanical strength and thermal endurance. The crosslinking may advantageously be effected only after the joining of the foam layer with the covering layer together with the latter, since in this way both the covering layer and the foam layer are crosslinked. This embodiment is particularly advantageous when the foam layer and the covering layer were directly joined to one another via a coextrusion as explained above. The crosslinking itself may be effected in any manner known per se to those skilled in the art, the use of high-energy radiation being preferable. To this end, electron radiation for example may be used.

The foam film laminates produced according to the invention are typically employed in areas where at least the compact covering layer is visible. In such applications, such as in the field of dashboard trim, it is often desirable to provide the surface of the foam film laminate with a texturing for reasons of appearance. To this end the covering layer may be provided with a three-dimensional texture in an embossing process before crosslinking. This texturing may be introduced into the still uncrosslinked covering layer and is fixed by the crosslinking step that follows so that during the subsequent forming, such as deep drawing for example, and also during subsequent thermal stress in the end application, for example strong solar radiation and associated heating, the surface of the foam film laminate retains its texture. A subsequent crosslinking of the foamed layer ensures that thermoforming stability is achieved even in the range of low foam densities of <300 kg/m³.

Crosslinking may be effected in such a way that after crosslinking the foam film laminate has a gel content of 10 to 80%, measured after 24 hour extraction in boiling xylene, preferably 15 to 65%, particularly preferably 15 to 40%. A laminate with such a gel content features advantageous stability for further processing.

In addition to the covering layer and the foamed layer the foam film laminate produced according to the invention may to further layers, for example metal foils or layers based on polymers, by thermal means or by adhesive bonding, on the side of the covering layer and/or the side of the foamed plastic. If further polymer layers are applied coextrusion may also be employed as a method of joining by thermal means.

The present invention further relates to a plastics composition for a foam layer for performing the process according to the invention, wherein the plastics composition contains the following ingredients:

−15 to 80 parts by wt of at least one first polymer having a content of polyethylene of at least 50 wt % based on the first polymer, wherein the first polymer is in particular polyethylene,

−15 to 80 parts by wt of at least one second polymer having a content of polypropylene of at least 50 wt % based on the second polymer, wherein the second polymer is in particular polypropylene,

−5 to 60 parts by wt of an HMS polyolefin having a stretching viscosity according to ISO 20965 (as at Feb. 15, 2005, type A measuring apparatus) of 10⁴ to 10⁷ Pa s measured at 190° C. in a Hencky strain rate range of 0.01 s⁻¹ to 1 s⁻¹ at a Hencky strain of 3.0, wherein the parts by weight of the polymers sum to 100, and

−0.1 to 5.0 wt % of at least one solid chemical blowing agent.

In the plastics composition according to the invention neither the first nor the second polymer are HMS polyolefins.

Further suitable additive substances, such as fillers, anti-ageing additives and flame retardants may be present in the composition in customary amounts.

The composition according to the invention makes it possible to obtain foam layers which have a foam density of 200 to 700 kg/m³ and may be subjected to deep drawing without the cells collapsing. Multilayered plastics films of low weight may thus be obtained. The proportion of 5 to 60 parts by wt of an HMS polyolefin, in particular in the form of HMS polyethylene, ensures uniform cell size in the obtained product while the proportion of 15 to 80 parts by wt of at least one polyethylene provides for sufficient low temperature flexibility coupled with good softness and economic product cost and the proportion of 15 to 80 parts by wt of at least one polypropylene provides for good heat resistance.

In a development of the plastics composition according to the invention the HMS polyolefin may contain or consist of a high melt strength polyethylene (HMS-PE), wherein the high melt strength polyethylene has a melt flow index MFI (190° C., 2.16 kg according to ISO 1133) of 0.05 to 2.0 g/10 min.

The plastics composition according to the invention may also be configured such that the HMS polyolefin contain or consist of a high melt strength polypropylene (HMS-PP), wherein the high melt strength polypropylene, wherein the polypropylene in particular has a melt flow index MFI (230° C., 2.16 kg according to ISO 1133) of 0.05 to 8.0 g/10 min.

The plastic composition according to the invention may likewise employ any desired mixtures of high melt strength polyethylene and high melt strength polypropylene.

The present invention further provides a foam film laminate produced or producible by the process according to the invention.

The invention finally provides for the use of a foam film laminate according to the invention for coating of components for vehicle interior trim. Further applications are in the field of manufacturing components in the airbag sector which advantageously eschew weakened areas or incisions for the tearing open of the laminate upon opening of the airbag. It is also possible in the multilayered plastics film for foamed and compact plastics layers to be arranged side by side under one covering layer so that the haptics may be adapted in different regions of the laminate.

The invention is hereinbelow more particularly elucidated with reference to exemplary embodiments reported in table 1.

Materials Used:

PP1: type: random polypropylene, MFI=1.8 g/10 min at 230° C.; 2.16 kg

PE1: type: linear low density polyethylene, MFI=1.0 g/10 min at 190° C.; 2.16 kg

PE2: type: linear low density polyethylene, MFI=1.9 g/10 min at 190° C.; 2.16 kg; stretching viscosity as per ISO 20965 (as at Feb. 15, 2005, type A measuring apparatus) of 10⁶ Pa·s at 190° C. at a Hencky Strain rate of 0.1 s⁻¹ at a Hencky Strain of 3.0

PP2: type: homopolypropylene, MFI=2.0 g/10 min at 230° C.; 2.16 kg

PP3: type: Random heterophase polypropylene copolymer, MFI=1.2 g/10 min at 230° C.; 2.16 kg

Methods of Measurement:

Stretching viscosity was determined to the standard ISO 20965 (as at Feb. 15, 2005) on a type A measuring apparatus according to Chapter 5.1 of the standard at the respective reported temperature, the reported Hencky strain rate and the reported Hencky strain. Heat resistance: Testing of thermal stability is performed with a foam sample having dimensions of 15 cm×15 cm onto which a cross having dimensions of 10×10 cm has been drawn from the center outward with a caliper. This foam sample is placed in a drying cabinet for 24 hours at several temperatures. After 24 hours the percentage shrinkage in the longitudinal and transverse directions is measured.

The temperature at which shrinkage of not more than 5% in the longitudinal and transverse directions occurs is defined as the thermal stability of the foam.

Modulus of elasticity: Tensile tests were performed to characterize the films in terms of their fundamental mechanical properties. The modulus of elasticity may be determined with this test. Said modulus is used to assess softness. In the tensile test a standardized test specimen is clamped between two clamping jaws and pulled apart at constant traverse speed. A load cell is used to record the forces that arise. In order to be able to compare samples having different cross-sections the force F is related to the starting cross section A₀. This gives tension σ.

The tension at the maximum recorded force is referred to as tensile strength σ_{M}. Elongation ε describes the lengthening ΔL based on the starting measured length L₀ of the test specimen. The modulus of elasticity is determined in Hooke's region in which deformation is reversible. This region is limited to small elongations. The modulus of elasticity E is the ratio of the change in stress Δσ to the change in elongation Δε and a measure of stiffness. The greater is E, the stiffer the material. The modulus of elasticity was determined by regression from 0.05% to 1% elongation at a rate of 1 mm/min. The tensile tests are performed to DIN EN ISO 527-3 at a rate of 2000 mm/min, to which rate the test rate is increased after modulus of elasticity determination. Type 5 test specimens are employed.

Stress at 100% elongation: to ISO 1926 (Rigid cellular plastics—Determination of tensile properties) procedure: A Zwick Roell Z010 tensile tester from Zwick was used to perform the tensile tests. Testing is performed at room temperature. The test specimen for the tensile tests at room temperature is the type 4 dumbell as per ISO-527-3. For performing the tensile/elongation tests at least five test specimens are stamped out of each foam sample in the longitudinal and transverse direction. Specimen thickness is measured with a thickness tester to an accuracy of 0.01 mm. The test specimen is clamped vertically at the clamping dumbell ends in the jaws of the tensile tester. In the tensile tests at room temperature strain sensors are used to eliminate measurement error due to elongation of the dumbell ends. The specimen is elongated to breakage at a rate of 500 mm/min.

Breaking stress: to ISO 1926 (Rigid cellular plastics—Determination of tensile properties)

Breaking elongation: to ISO 1926 (Rigid cellular plastics—Determination of tensile properties)

Table 1 reports the polymer constituents of the respective compositions in parts by weight. In addition, every formulation contains 3 parts by weight of Hydrocerol 592 (60 wt % of polyethylene and 40 wt % of citrate). Hydrocerol 592 is based on a salt of citric acid. This citrate is produced by neutralization of citric acid with aqueous sodium hydroxide solution. Citric acid is produced from molasses by biological fermentation, i.e. is virtually a natural product from renewable raw materials. The CO2 formed in the decomposition was previously bound in biomass, i.e. derives from a cycle and does not represent additional CO2. 2 parts by weight of UV stabilizer (HALS—sterically hindered phenol) and 1 part by weight of black dye composed of 85 wt % polyethylene and 15 wt % carbon black.

TABLE 1
Composition of inventive examples 1 to 15

| Example | PP1 | PE1 | PP2 | PP3 | PE2 |
|---|---|---|---|---|---|
| 1 | 20 | 60 | | | 20 |
| 2 | 35 | 45 | | | 20 |
| 3 | 20 | 40 | | | 40 |
| 4 | 35 | 25 | | | 40 |
| 5 | 27.5 | 42.5 | | | 30 |
| 6 | | 60 | 20 | | 20 |
| 7 | | 45 | 35 | | 20 |
| 8 | | 40 | 20 | | 40 |
| 9 | | 25 | 35 | | 40 |
| 10 | | 42.5 | 27.5 | | 30 |
| 11 | | 60 | | 20 | 20 |
| 12 | | 45 | | 35 | 20 |
| 13 | | 40 | | 20 | 40 |
| 14 | | 25 | | 35 | 40 |
| 15 | | 42.5 | | 27.5 | 30 |

The components for the elastomer compositions reported in table 1 were initially mixed and extruded on a twin-screw extruder and the temperature prevailing in the extruder head, ahead of the die, was approximately 210° C. A slit die having a die width of 30 cm and a die gap of 0.5 mm was used. As a result of the extrusion temperature foam films having the densities reported in the table were obtained directly.

The physical properties of the foam films without a covering layer were then analyzed. A covering layer was eschewed in the tests to prevent distortion of the results owing to the covering layer . The results are summarized in table 2 which follows:

TABLE 2
Results

| | | Heat | Modulus | Stress at | Break- | Breaking |
|---|---|---|---|---|---|---|
| Ex- | | resis- | of | 100% | ing | elon- |
| am- | Density | tance | elasticity | elongation | stress | gation |
| ple | [g/cm³] | [° C.] | N/mm² | MPa | [N] | [%] |
| 1 | 689 | 100 | 43.68 | 4.98 | 8.15 | 1160.3 |
| 2 | 636 | 130 | 57.16 | 18.03 | 7.03 | 1052.7 |
| 3 | 613 | 130 | 66.39 | 17.44 | 7.59 | 1090.7 |
| 4 | 612 | 120 | 49.53 | 16.43 | 7.12 | 1252.3 |
| 5 | 640 | 130 | 94.89 | 25.86 | 7.88 | 880.6 |
| 6 | 670 | 120 | 34.51 | 9.32 | 5.61 | 1066.13 |
| 7 | 604 | 130 | 117.56 | 21.66 | 8.68 | 865.2 |
| 8 | 625 | 130 | 96.26 | 17.96 | 7.18 | 663.8 |
| 9 | 609 | 120 | 59.12 | 15.06 | 7.08 | 1122.6 |
| 10 | 582 | 130 | 154.08 | 25.99 | 8.61 | 677.2 |
| 11 | 691 | 100 | 19.86 | 6.34 | 4.89 | 1255.2 |
| 12 | 637 | 130 | 51.09 | 10.87 | 5.64 | 812.1 |
| 13 | 649 | 130 | 58.56 | 10.66 | 6.23 | 783.1 |
| 14 | 582 | 100 | 42.52 | 10.48 | 5.19 | 990.3 |
| 15 | 563 | 130 | 83.61 | 15.03 | 6.41 | 760.3 |

The examples demonstrate that the inventive compositions for producing a plastics foam layer/a foam film laminate in the context of the process according to the invention foam layers having good mechanical properties may be produced directly during extrusion using a solid chemical blowing agent. In other words it is accordingly not necessary for the compositions to be initially extruded to afford a very largely compact film and after crosslinking subjected to foaming since on account of the inventive usage amounts of HMS polyolefins the compositions have a sufficient retaining capacity for the gases liberated from the solid chemical blowing agent in the course of the process even in the extruder in the form of a melt.

It is furthermore apparent from table 2 that the foamed films have a low weight but nevertheless have sufficient stability at stretch ratios of more than 300% during deep drawing.

The foam film laminate produced by the process according to the invention features low production costs and good deep drawing properties, allows for weight saving and due to the less complex production process requires less energy and raw materials. In addition, when the laminate is used in automotive interiors less energy is required to move the vehicle due to the lighter weight.

1-17. (canceled)

18. A process for producing a foam film laminate comprising at least one compact covering layer and at least one layer of extruded foamed plastic joined to the covering layer, wherein the production of the layer of foamed plastic is effected in a manner where a plastics material is admixed with a chemical blowing agent which is solid at room temperature and during or after extrusion is heated to or above an activation temperature of the chemical blowing agent to obtain the layer of foamed plastic; and,
wherein the plastics material contains 5 wt % to 60 wt % of at least one HMS polyolefin having a stretching viscosity according to ISO 20965 (as at Feb. 15, 2005, type A measuring apparatus) of 104 to 107 Pa-s measured at 190° C. in a Hencky strain rate range of 0.01 s-1 to 1 s-1 at a Hencky strain of 3.0.

19. The process as claimed in claim 18, wherein the plastics material contains 10 wt % to 55 wt % of the at least one HMS polyolefin.

20. The process as claimed in claim 19, wherein the plastics material contains 15 wt % to 50 wt % of the at least one HMS polyolefin.

21. The process as claimed in claim 18, wherein the at least one HMS polyolefin is selected from HMS polyethylene, HMS polypropylene, copolymers thereof or mixtures thereof.

22. The process as claimed in claim 18, wherein the blowing agent is selected from endothermic and exothermic solid chemical blowing agents.

23. The process as claimed in claim 22, wherein the blowing agent is selected from in particular from citric acid salts.

24. The process as claimed in claim 23, wherein the blowing agent is selected from in particular from citric acid alkali metal salts, citric acid alkaline earth metal salts, citric acid ammonium salts, citric acid sodium hydrogencarbonate salts, citric acid azodicarbonamide salts or mixtures thereof.

25. The process as claimed in claim 18, wherein that the activation temperature of the solid chemical blowing agent is 180° C. or more.

26. The process as claimed in claim 18, wherein the content of solid chemical blowing agent based on the plastics material for the layer of foamed plastic is 0.1 wt % to 5 wt %.

27. The process as claimed in claim 18, wherein the admixing of the plastics material with the blowing agent is effected by mixing the plastics material in the form of a melt, as a pellet material or in powder form with the blowing agent.

28. The process as claimed in claim 18, wherein after extrusion and cooling of the layer of foamed plastic below the melting temperature of the plastics material the compact covering layer is joined to the foam layer by thermal means or by adhesive bonding or that the covering layer and the layer of foamed plastic are joined to one another during a coextrusion.

29. The process as claimed in claim 18, wherein the foamed plastic layer undergoes crosslinking after foaming, wherein the crosslinking is in particular effected only after the joining of the foam layer with the covering layer, together with the latter.

30. The process as claimed in claim 29, wherein the covering layer is provided with a three-dimensional texture in an embossing process before crosslinking.

31. The process as claimed in claim 29, wherein the crosslinking is effected in such a way that after crosslinking the foam film laminate has a gel content of 10-80%, measured after 24 hours extraction in boiling xylene.

32. The process as claimed in claim 18, wherein the foam film laminate is joined to further layers based on polymers, by thermal means or by adhesive bonding, on the side of the covering layer and/or the layer of foamed plastic.

33. The process as claimed in claim 18, wherein the foam film laminate is used as coating of components for vehicle interior trim.

34. A plastics composition for a foam layer of a foam film laminate, wherein the foam layer comprises a plastics composition comprising:
15 to 80 parts by wt of at least one first polymer having a content of polyethylene of at least 50 wt % based on the at least one first polymer;
15 to 80 parts by wt of at least one second polymer having a content of polypropylene of at least 50 wt % based on the at least one second polymer;
5 to 60 parts by wt of an HMS polyolefin having a stretching viscosity according to ISO 20965 (as at Feb. 15, 2005, type A measuring apparatus) of 104 to 107 Pa-s measured at 190° C. in a Hencky strain rate range of 0.01 s-1 to 1 s-1 at a Hencky strain of 3.0, wherein the parts by weight of the polymers sum to 100; and,
0.1 to 5.0 wt % of at least one solid chemical blowing agent.

35. The plastics composition as claimed in claim 34, wherein the HMS polyolefin contains or consist of a high melt strength polyethylene (HMS-PE), and wherein the high melt strength polyethylene has a melt flow index MFI (190° C., 2.16 kg according to ISO 1133) of 0.05 to 2.0 g/10 min

36. The plastics composition as claimed in claim 34, wherein the HMS polyolefin contains a high melt strength polypropylene (HMS-PP), and wherein the high melt strength polypropylene, wherein the polypropylene in particular has a melt flow index MFI (230° C., 2.16 kg according to ISO 1133) of 0.05 to 8.0 g/10 min.

37. A process for producing a foam film laminate comprising at least one compact covering layer and at least one layer of extruded foamed plastic joined to the covering layer, wherein the production of the layer of foamed plastic is effected in a manner where a plastics material is admixed with a chemical blowing agent which is solid at room temperature and during or after extrusion is heated to or above an activation temperature of the chemical blowing agent to obtain the layer of foamed plastic;
wherein the plastics material contains 5 wt % to 60 wt % of at least one HMS polyolefin having a stretching viscosity according to ISO 20965 (as at Feb. 15, 2005, type A measuring apparatus) of 104 to 107 Pa-s measured at 190° C. in a Hencky strain rate range of 0.01 s-1 to 1 s-1 at a Hencky strain of 3.0;
wherein the foamed plastic layer undergoes crosslinking after foaming, wherein the crosslinking is in particular effected only after the joining of the foam layer with the covering layer, together with the latter; and,
wherein the crosslinking is effected in such a way that after crosslinking the foam film laminate has a gel content of 10-80%, measured after 24 hour extraction in boiling xylene.

38. The process as claimed in claim 37, wherein the covering layer is provided with a three-dimensional texture in an embossing process before crosslinking.
